(19) United States
(12) Patent Application Publication
(10) Pub. No.: US 2022/0084042 A1
(43) Pub. Date: Mar. 17, 2022

(54) METHOD FOR ENSURING THE AUTHENTICITY AND VALIDITY OF ITEM OWNERSHIP TRANSFER

(71) Applicant: CASHIERBOOK SDN. BHD., Selangor Darul Ehsan (MY)

(72) Inventor: Tiong Yew TANG, Kuala Lumpur (MY)

(21) Appl. No.: 17/262,833

(22) PCT Filed: Dec. 23, 2019
(86) PCT No.: PCT/MY2019/000050

§ 371 Date: Jan. 25, 2021

(51) Int. Cl. G06Q 30/00; G06F 16/28; H04L 9/08

(52) U.S. Cl. CPC G06Q 30/018; H04L 9/088; G06F 16/284

(57) ABSTRACT

The present invention describes a method for a secure crossover hashing process of an item's physical identity and digital identity. Three layers are involved in the method of the invention which are the physical layer (303), database layer (302) and blockchain layer (301).

The digital item identity in the digital layer stores the digital item's identity (213) as a database table record in a relational database management system (217). The physical item identity is stored in a NFC or RFID tag.

The invention performs multi-layer hashing of the item's physical identity and digital identity to ensure the authenticity of the item as well as its physical identity and digital identity. The invention further verified and secures the item's ownership history by an information hashing process with blockchain distributed ledger technology.

The present invention relates to a computer-implemented system for ensuring authenticity of an item as well as items sold second hand to another party. More specifically, the invention comprises a method for authenticating an item, verifying the ownership of the item and validating item ownership transfer using the blockchain.

### DESCRIPTION OF THE PRIOR ART

Counterfeit items find their way to the consumer through the supply chain. The challenge of tracking items throughout the supply chain and the inability for its participants to create a proof of possessing goods is a barrier to fighting counterfeiting and monitoring how items are moving through the supply chain. Ensuring that the item is authentic (i.e., registered by the legitimate party), ensuring that a transfer is valid (i.e., the sender actually owns it and the recipient is the only one receiving it) while maintaining transaction confidentiality are critical properties for a system.

RFID technology has long provided effective countermeasures through track-and-trace or authentication solutions. However, RFID tags are vulnerable to tampering.

Prior implementations of such systems require the disclosure of the transactions to a custody registry. Such implementations might be based on simple central databases which might not be desirable because the disclosed information is confidential amongst the parties involved in the transactions. Further, the registry is typically a centralized system and vulnerable to data manipulation attack.

US 2008/0005557 A1 discloses a method allowing the authentication of collectibles or other valuable items. The method affixes a unique and randomly generated identifying number to each item. A unique password is then associated with each identifying number. The set of identifying numbers and associated passwords are stored in random order in a registration database server. Public access to the system is provided through a public access server. The public access server communicates with a registration database server via random paths over the Internet.

In the above application, the security and integrity of the data in the registration database cannot be trusted. Often, an attacker who has penetrated a computer network will modify or tamper records in a registration database that are intended to be confidential. Further, in many cases, the attacker may be a credentialed entity within a network, such as a rogue employee, making many traditional approaches to a registration database security inadequate in some cases.

US 20190205894 A1 discloses a method for tracking transfer of an item on an item tracking data blockchain, where transfers of the item and the holder of the item are recorded in item tracking data blocks of the blockchain. In some examples, a verification of the item is performed for a transfer and recorded in the data block for the transfer. In other examples, the blockchain stores a unique code for the ticket. Transfers of the ticket are recorded in the blockchain. When the ticket is presented for use, a holder identifier and a presented ticket code are validated against a holder identifier in the most recent block in the blockchain and the unique code for the ticket stored in the blockchain.

U.S. Pat. No. 10,075,298 B2 discloses a process including obtaining a plurality of records to be protected; forming a tamper-evident log configured to prevent an attacker from undetectably modifying any of the plurality of records stored in the tamper-evident log, wherein the cryptographic hash value of a given entry in the tamper-evident log is sequence agnostic to the sequence of entries in virtue of being based on values that do not specify a position in the sequence of entries; and storing the tamper-evident log in memory.

The above applications however only protect records in the blockchain and do not provide for protection of the physical identity of the item and its related records in a database.

None of the above, taken either singularly or in combination, is seen to describe the invention as claimed. Thus, a method ensuring authenticity and validity of item ownership transfer solving the aforementioned problems is desired, especially for high value item trading industry such as fine arts, antiques, jewellery, collectable items, limited edition, expensive machinery and expensive pharmaceutical products.

### SUMMARY OF THE INVENTION

In accordance with an aspect of the invention, there is provided a computer-implemented method of authenticating the ownership of an item, comprising:

configuring tagging data of a tagging device to be affixed to said item;
wherein said tagging data comprises of a Unique ID, a Serial Number, a Reference Number and a key;
at least the Unique ID is encrypted into ciphertext using the key and is stored in the tagging device;
   configuring a relational database table, wherein the contains at least a Unique ID, a Reference Number and a key but exclusive of the Serial Number of said tagging data;
   assigning a token to a blockchain account of the current owner and storing the token value in a specific record of the database;
   receiving ciphertext, Serial Number and Reference Number from said tagging device and generated by the current owner of the item;
wherein said tagging device Reference Number Identifies the specific record in said relational database table having the same Reference Number;
   confirming the authenticity of said item by matching the tagging data wherein the matching comprises of:
accessing the related relational database table specific record identified by said

Reference Number;
retrieving the key from the relational database table record;
decrypting the ciphertext using the key; and
verifying data are a match when the Unique ID in said relational database table record and decrypted ciphertext are identical.

In another aspect of the invention, a method of transferring the ownership of an item, that has been authenticated using the aforementioned method, comprises of:

transferring said token from the current owner's blockchain account to a blockchain account of an administrator;
transferring the item to a buyer;
validating physical transfer of the item; and
transferring the token from the administrator account to a blockchain account of a buyer.

The invention thus authenticates the item as well as verifies that the item is valid for ownership transfer. Such feature is very useful in high value item trading industry as the seller must be a legitimate party i.e. the seller actually owns and is in possession of the item and ensures that the transfer is valid i.e. the physical and digital item identities match.

This invention utilizes blockchain to secure data. The token is used to manage and provide traceability and visibility into the ownership history of the item from its origin to the latest seller, in a manner that is decentralized and globally accessible with high integrity, resiliency, and transparency.

In one embodiment of the invention, the tagging device further contains a COUNT value and a padding value which is encrypted with the Unique ID into the ciphertext using the key.

In a further embodiment of the invention, the relational database table further contains a Customer ID value representing said current owner's information, a product ID value representing said item's information and a Token Name value representing the name that is given to said token for securing ownership data of said item.

These values are useful when the hashing function is utilized in another embodiment of the invention.

In another aspect of the invention, a method of validating physical transfer of an item where the buyer is in physical possession of said item further comprises:

retrieving the public address value of the token;
retrieving the Customer ID value from said relational database table;
generating a first hash value using the public address value and Customer ID as key and storing said first hash value in the relational database table;
generating a second hash value using the first hash value and Product ID as key and storing said second hash value in the relational database table; and
generating a third hash value using the second hash value and Token Name value as key and storing said third hash value in the relational database table;
generating a final hash value using the third hash value and Serial Number value as key and storing said final hash value in the blockchain as a second transaction message.

In another aspect of the invention, a method of validating physical transfer of an item where the buyer is in physical possession of said item further comprises:

retrieving the public address value of the token;
retrieving the Customer ID value from said relational database table;
generating a first hash value using the public address value and Customer ID as key and storing said first hash value in the relational database table;
generating a second hash value using the first hash value and Product ID as key and storing said second hash value in the relational database table; and
generating a third hash value using the second hash value and Token Name value as key and storing said third hash value in the relational database table;
generating a final hash value using the third hash value and Serial Number value as key and storing said final hash value in the blockchain as a transaction message n+2;
wherein n is the number of transactions.

This strengthens the information binding between physical and digital identities of the item through multi-layer protection. It also enhances information integrity of the item's identity for the transaction. The strengthening and enhancing is essential because the database layer is a centralised system and it is vulnerable to data manipulation attack.

An attacker will not be able to reverse engineer the hash values without the physical layer serial numbers that are not available at the database layer. Only the authentic seller will have the physical item with the serial numbers in the tag.

In a further embodiment, the invention provides a method of binding ownership information of a token that has been transferred to the buyer, said method comprising: retrieving the public address value of the token and storing said value as a first transaction message;

generating a hash value using said first transaction message value and the second transaction message value as key; and
storing said hash value in the blockchain as a third transaction message.

In a further embodiment, the invention provides a method of binding ownership information of a token that has been transferred to the buyer, the method comprising:

generating a hash value using the transaction message n+1 value as data and the transaction message n+2 value as key; and
storing said hash value in the blockchain as transaction message n+3.

The crossover validation process performs a full hash value calculation comparison i.e. verifying whether transaction message Msg 2 and transaction message Msg 4 hash values in the database and transaction message Msg 2 and transaction message Msg 4 hash values in the blockchain layer are the same. If the transaction messages are different, this shows that an attempt to manipulate item ownership information has been made and the system will be alerted of the breach.

### BRIEF DESCRIPTION OF THE DRAWINGS

FIG. 1 is a diagram of the three layers involved in the present invention.

FIG. 2 is a detailed diagram of the digital layer and the physical layer of the invention and describes the encryption process.

FIG. 3 is a flowchart showing the tag tamper status scenarios of a tagging device.

FIG. 4 is a flowchart showing explaining the logic just after FIG. 3 logic flowchart diagram and how it handles if the physical and digital item's identity if their identities are the same or not.

FIG. 5 is a flowchart describing the hash function processing.

FIG. 6 is a flowchart describing the hashing at the database layer with iteration approach for the serial number for one or more tagging device.

### DETAILED DESCRIPTION OF THE EMBODIMENTS

The invention is a method which uses the blockchain architecture as an immutable database register of an item, and at the same time, ensures that the transaction is valid that will guarantee to the buyer the authenticity of the item.

Additionally, the buyer is able to extract item information such as brand, model, origin, history along the ownership chain. The method also utilises the blockchain to transfer ownership rights from a seller to a trader and then to the buyer with ease.

Even though this embodiment describes a method for selling and buying a piece of art, the present invention can be applied to other high value physical items such as antiques, jewelry, collectable items, limited edition items, expensive machinery and expensive pharmaceutical products.

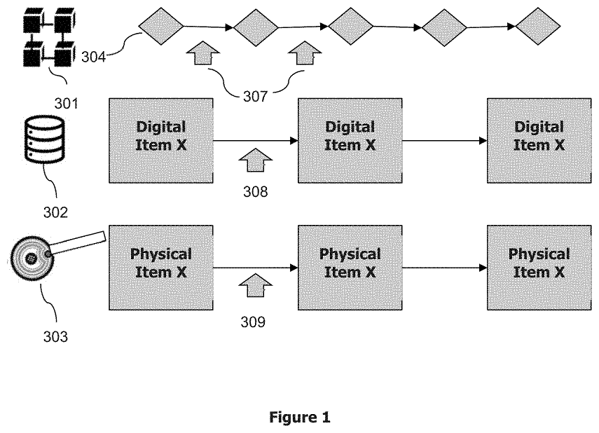

FIG. 1 illustrates the three layers involved in the method of the present invention which are the physical layer 303, database layer 302 and blockchain layer 301. The database layer 302 and blockchain layer 301 make up the digital layer. Physical item ownership transfer 309 will trigger the digital item ownership transfer 308 which initiates the relational database table to perform update of ownership information. Subsequently, the digital item ownership transfer 308 will trigger the blockchain layer 301 to transfer token ownership to a buyer 307. Item ownership transfers will be explained further in the description.

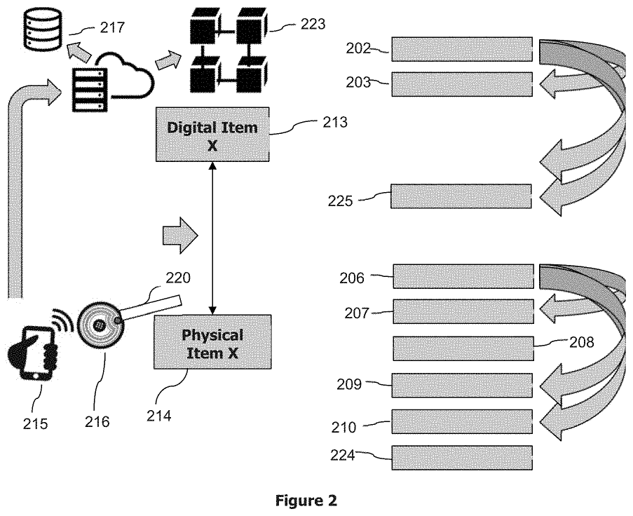

FIG. 2 illustrates the relationship between a physical item identity in the physical layer and a digital item identity in the digital layer as well as the verification process of the identities.

The physical item 214 can be any item. Each physical item is affixed with at least one tagging device such as a NFC or RFID tag 216. The NFC or RFID tag 216 consists of three basic components: a chip, an antenna and something to keep it together. The NFC chip contains a small amount of memory and the technology that allows it to communicate. The NFC or RFID tag 216 comes with a pre-programmed Unique ID. Data such as the Unique ID is typically stored in the memory on a tag.

If the item comes in parts or a set, for example, a jewelry set comprising of a necklace and two earrings, the necklace and each earring can have one tag affixed to it.

The digital layer stores the digital item's identity 213 as a database table record in a relational database management system 217. The physical item identity is stored in the NFC or RFID tag 216.

The relational database table stores a decryption key 202, a Unique ID 203 which is the digital item's unique identity value to identify the tag and a Reference Number 225 for referencing which record stores the relevant decryption key 202 and Unique ID 203.

The tag stores an encryption key 206, a Unique ID 207 which is the physical item's unique identity value to identify the tag, a PAD value 209 which is the value that will be added on to strengthen the encryption process and a COUNT value 210 which records the number of times that the tag is read.

The Unique ID 207, PAD 209 and COUNT 210 are encrypted using the encryption key 206 into ciphertext and is stored in the tag's memory. The tag also stores a Reference Number which will be used to reference which record in the relational database table stores the relevant decryption key 202, Reference Number 225 and Unique ID 203.

Encrypting the Unique ID 207, PAD 209 and COUNT 210 ensures that no eavesdropper can read the message. Encryption also ensures the integrity of the data at the receiver will receive the exact same message that was sent by the sender. Additionally, it also confirms that the message was sent by a legitimate party and not an imposter as the ciphertext is transmitted to the receiver, who uses the same key to decrypt the cipher text and obtains the plain text. Although it is possible for a hacker to gain access to the tag, all that the hacker would get would be ciphertext which they would have a hard time decrypting without a key. Further explanation on decryption will be provided in the description.

Further, the tag also comes with a pre-programmed Serial Number. This Serial Number can be changed or assigned by the trader. Preferably, the Serial Number is randomly generated and assigned. In the instance that an item is affixed with more than one tag, the trader will assign each tag with a random Serial Number and does not need to be in a specific sequence. This enhances the security of the tagging devices as it is not possible for a malicious intent user to guess the serial numbers.

In an embodiment, the tag only encrypts the Unique ID 207 as only the Unique ID 207 is required to verify the item's identity.

In addition to the Unique ID 207, Reference Number 225 and Key 202, the relational database table also stores a Customer ID value, a Product ID value, and a Token Name value. These values represent the item information. For example, the Customer ID value represents the seller's information. The Product ID value represents the product information such as the description of the item. The Token Name value represents the name that is given to the token. This information is assigned by the trader.

As a security measure, the relational database table does not store the Serial Number(s) of the tag(s) since the database is vulnerable.

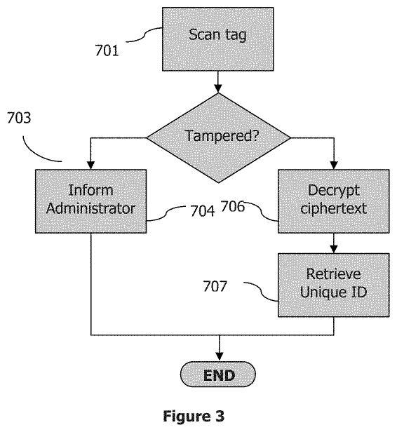

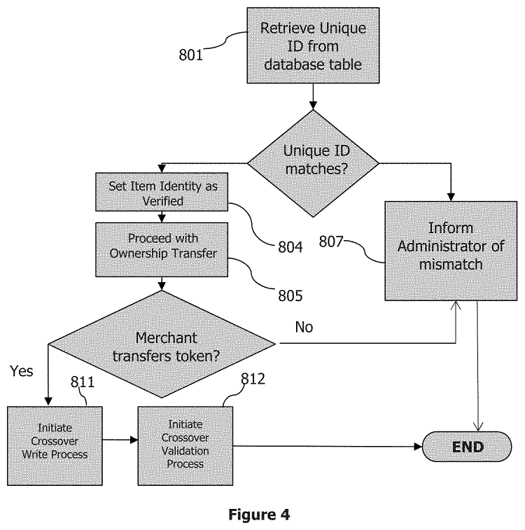

FIGS. 3 and 4 are a flowchart showing a method for confirming the authenticity of an item and securing the identity of the item.

Any unauthorized attempt to tamper or remove the tag will be detected 703 and recorded in the tag. The tamper detection status can be checked via the trader's system. When tampering is detected, the tag can no longer be used for item ownership transfer. This offers higher security and improved counterfeiting protection. Consequently, this will void the validity of both the physical and digital item identities when the tag is subsequently scanned.

An example of embodiments of the present invention is detailed below.

### First Instance—Artist to First Buyer

A piece of art is created by an artist. The artist now intends to sell the piece of art and engages a trader to sell the art.

Once the trader approves the engagement, the trader will create a token and transfer the token to the artist. Every token belongs to a blockchain address i.e. a public address. Only the person who has the private key for that address can access the token. In this case, only the artist has access to the token via the trader's system 217 and is the owner of that token. The owner can initiate transfer of the token by signing with their private key.

The trader will give access credentials to the artist such as a username and/or password that allows the artist to log in to the trader's system database. Preferably, a web interface is used.

The trader will then provide the artist with a physical NFC or RFID tag 216 for the artist to affix to the piece of art.

It is to be noted that the art may not be sold instantaneously and the next step may happen only several months or years later.

Once the art is sold and the artist receives payment from the buyer, the artist will transfer their token to the trader using their private key.

The artist will then log in to their trading account and scan the tag affixed to the Item using a tag reader 701 to confirm the authenticity of the item as illustrated in FIG. 3.

When the tag is scanned using a tag reader, the Reference Number is used to find the relevant record with matching Reference Number in the relational database table required for confirming the authenticity of the item. Once the relevant record has been found, the ciphertext is decrypted 706 using the decryption key 202 into plaintext consisting of Unique ID 207, PAD 209 and COUNT 210. If both Unique ID values in the physical layer and digital layer match 707, 801, then the identity of the item is verified 804.

In an embodiment where there is more than one tag for the item, once all the tags have been scanned, the Serial Number of the tags will be sorted in an ascending sequence and temporarily stored in the relational database table.

Once the item is verified 804, it will trigger the trader to proceed with ownership transfer of the item 805. Further, the trader will then deliver the item to the buyer.

Further, if the Unique ID values are not a match, then the system will inform the trader of the mismatch and the item identity will remain as unverified 807.

Upon receipt of the item, the buyer logs in to their trading account and will scan the tag using a tag reader to confirm that they are in receipt of the item and to record the ownership transfer as valid.

Next, the crossover write process 811 will be initiated.

However, as a prevention measure, then crossover write process 811 and crossover validation process 812 will not be carried out if the trader account is not the account that transfers the token to the buyer. Since the crossover process cannot be carried out, any further attempts at scanning the tag to will not be successful as a full hash value comparison cannot be completed.

The transaction where the trader transfers the token to the buyer comes with its own transaction ID (TXID), a string of letters and numbers that makes it unique. The TXID contains details such as the fee paid, the sending/receiving public address and the date of transfer. This TXID provides proof of a successful transfer. Each and every single transaction that is conducted on the blockchain has this unique TXID identifier.

Hashing is one way to enable security during the process of message transmission. If the TXID i.e. transaction message values are modified in any way, the value of the hash will also change significantly. Changing any variable of any one of the hashes in the blockchain would also cause a domino effect, altering all of the previous transactions in the block. Consequently, the transaction cannot be validated and will not pass the crossover validation process in view of the manipulated transaction messages.

The PUB value which is the public address representing the artist's account at the blockchain layer is required for the crossover process.

Hashing function is applied using the PUB value as data and the Customer ID value as key. The resulting hash value is stored as an ECY value at the database layer.

Next, hashing function is applied using the ECY value as data and Product ID value as key. The resulting hash value is stored as an ECY value at the database layer.

Then, hashing function is applied using the ECY value as data and Token Name value as key. The resulting hash value is stored as an ECY value at the database layer.

Next, the trader will transfer the token to the buyer 307 and initiate the crossover validation process 812.

Subsequently, hashing function is applied using the ECY value as data and the Serial Number as key. This resulting hash value is the final ECY value and will be stored at the blockchain layer as transaction message Msg 2 607. The transaction message value will be re-calculated during crossover validation process to ensure data integrity. The transaction message value also stores the hash values for future hashing.

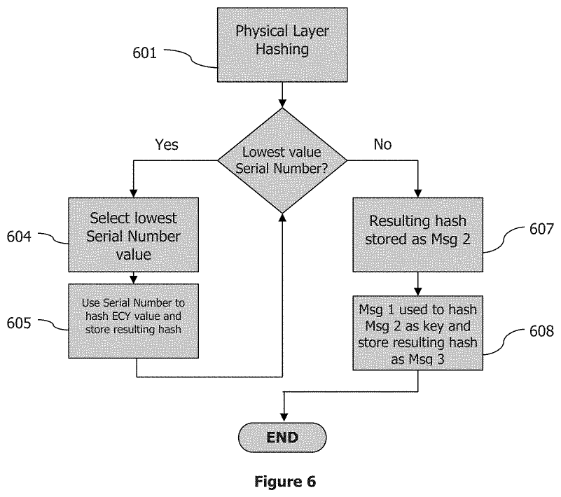

In the event that there is more than one tag for the item, the hashing function is applied to every resulting hash value and the subsequent Serial Number as key until the last of the serial numbers as illustrated in FIG. 6. The hashing function 601 is applied to every resulting hash value using the largest Serial Number value as key until the lowest Serial Number value 604, 605.

The hashing function is applied using the ECY value (previous hash value of ECY and Token Name) as data and the Serial Number 1 as key. The resulting hash value is stored as an ECY value at the database layer.

The hashing function is applied using the ECY value (previous hash value of ECY and Serial Number 1) as data and the Serial Number 2 as key. The resulting hash value is stored as an ECY value at the database layer.

The hashing function is applied using the ECY value (previous hash value of ECY and Serial Number 2) as data and the Serial Number 3 as key. The resulting hash value is stored as an ECY value at the database layer.

Next, the trader will transfer the token to the buyer 307 and initiate the crossover validation process 812.

The hashing function is applied using the ECY value (previous hash value of ECY and Serial Number 3) as data and the Serial Number 4 as key. This resulting hash value is the final ECY value and will be stored at the blockchain layer as transaction message Msg 2 607. The transaction message value will be re-calculated during crossover validation process to ensure data integrity. The transaction message value also stores the hash values for future hashing.

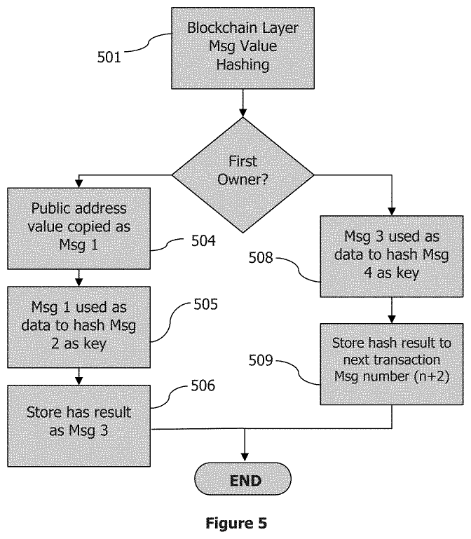

FIG. 5 illustrates the steps to hash transaction message values from the blockchain layer.

The PUB value is copied and stored as transaction message Msg 1 since there is no previous transaction record 504. Hashing function 501 is applied using Msg 1 value as data and transaction message Msg 2 value as key 505. The resulting hash value is stored in the blockchain layer as transaction message Msg 3 506.

The hashing process stops until the next transfer of token i.e. when there Is a subsequent buyer.

### Subsequent Instance—First Buyer to Subsequent Buyer

Once the art is sold and the first buyer receives payment from the subsequent buyer, the first buyer will transfer his token to the trader using his private key.

The first buyer will then log in to his trading account scan the tag affixed to the item using a tag reader to confirm the authenticity of the item as illustrated in FIG. 3.

When the tag is scanned using a tag reader, the Reference Number is used to find the relevant record with matching Reference Number in the relational database table required for confirming the authenticity of the item. Once the relevant record has been found, the ciphertext is decrypted 706 using the decryption key 202 into plaintext consisting of Unique ID 207, PAD 209 and COUNT 210. If both Unique ID values in the physical layer and digital layer match 707, 801, then the identity of the item is verified 804.

In an embodiment where there is more than one tag for the item, once all the tags have been scanned, the Serial Number of the tags will be sorted in an ascending sequence and temporarily stored in the relational database table.

Once the item is verified 804, it will trigger the trader to proceed with ownership transfer of the item 805 and to deliver the item to the buyer.

Further, if the Unique ID values are not a match, then the system will inform the trader of the mismatch and the item identity will remain as unverified 807.

Upon receipt of the item, the subsequent buyer will log in to his trading account scan the tag using a tag reader to confirm that he is in receipt of the item and to record the ownership transfer.

Next, the crossover write process 811 will be initiated.

If the trader account is not the account that transfers the token to the buyer, then crossover write process and crossover validation process will not be carried out.

The PUB value of the buyer and transaction message Msg 3, which was generated from the previous transaction, is required for the crossover process.

Hashing function is applied using the PUB value as data and the Customer ID value as key. The resulting hash value is stored as an ECY value at the database layer.

Next, hashing function is applied using the ECY value as data and Product ID value as key. The resulting hash value is stored as an ECY value at the database layer.

Then, hashing function is applied using the ECY value as data and Token Name value as key. The resulting hash value is stored as an ECY value at the database layer.

Next, the trader will transfer the token to the buyer 307 and initiate the crossover validation process 812.

Subsequently, hashing function is applied using the ECY value as data and the Serial Number as key. This resulting hash value is the final ECY value and will be stored at the blockchain layer as transaction message Msg 4. The transaction message value will be re-calculated during crossover validation process to ensure data integrity. The transaction message value also stores the hash values for future hashing.

In the event that there is more than one tag for the item, the hashing function is applied to every resulting hash value and the subsequent Serial Number as key until the last of the serial numbers as illustrated in FIG. 6. The hashing function 601 is applied to every resulting hash value using the largest Serial Number value as key until the lowest Serial Number value 604, 605.

The hashing function is applied using the ECY value (previous hash value of ECY and Token Name) as data and the Serial Number 1 as key. The resulting hash value is stored as an ECY value at the database layer.

The hashing function is applied using the ECY value (previous hash value of ECY and Serial Number 1) as data and the Serial Number 2 as key. The resulting hash value is stored as an ECY value at the database layer.

The hashing function is applied using the ECY value (previous hash value of ECY and Serial Number 2) as data and the Serial Number 3 as key. The resulting hash value is stored as an ECY value at the database layer.

The hashing function is applied using the ECY value (previous hash value of ECY and Serial Number 3) as data and the Serial Number 4 as key. This resulting hash value is the final ECY value and will be stored at the blockchain layer as transaction message Msg 4. The transaction message value will be re-calculated during crossover validation process to ensure data integrity. The transaction message value also stores the hash values for future hashing.

FIG. 5 illustrates the steps to hash transaction message values from the blockchain layer.

Hashing function 501 is applied using transaction message Msg 3 value, which was generated from the previous transaction, as data and transaction message Msg 4 value as key 508. The resulting hash value is stored in the blockchain layer as transaction message Msg 5 509.

The hashing process stops until the next transfer of token i.e. when there is a subsequent buyer.

Once the crossover writes process is complete, the crossover validation process is performed where the full hash value and hash values are compared. The full hash value calculation is calculated from the first transaction up to the last transaction.

If the transaction message Msg 2 and transaction message Msg 4 values in the relational database and transaction message Msg 2 and transaction message Msg 4 values from the blockchain layer are different, then the system will alert the trader of possible data manipulation which may have occurred in the database layer. Different transaction message Msg 2 and transaction message Msg 4 would mean that changes to the original database's data, such as the Customer ID value, the Product ID value, and the Token Name value, have been made.

After the crossover validation is successfully completed, the temporarily stored serial numbers will be deleted from the relational database table.

This crossover security enhancement method binds the digital and physical item's identity together as one unified entity with information hashing approach. The objective of this approach is to prevent unauthorized tampering of item's authentication data in either one of the three layers as illustrated in FIG. 1 to preserve item's identity integrity. For example, any unauthorized modification to the ownership or item's identity data in any of the three layers will result in a mismatch of hash values.

Since the database layer is a centralized system, it is vulnerable to attacks. By combining the physical layer (data unavailable) and blockchain layer (data immutable), the database layer will have data unavailable and immutable properties for enhanced data security protection. Hence, any unauthorized tampering will be detected by hash values comparison i.e. the crossover validation process 812 and the item's identity integrity will be preserved.

Further, the attackers will not be able to reverse engineer to compute the hash values without the physical layer Serial Number which is not available at database layer and is only available at physical layer 303. Only the legitimate owner will be in possession of the physical item affixed with the tag(s) with the Serial Number(s) during the crossover write process 811 and crossover validation process 812. In conclusion, the three layers in the present invention will have enhanced data security protection.

Advantageously, the invention also enables track and trace of item's ownership historical data for the item's origin preservation. The buyer, seller and trader can authenticate and trace the origin of the item's ownership history. Since it is almost impossible to change the item's ownership data, the true value of the item can be retained and increased as the trader's system can prove the item's origin with the item's ownership historical data through the immutable, always available and transparent features of blockchain technology.

1. A computer-implemented method of authenticating the ownership of an item, comprising:
configuring tagging data of a tagging device to be affixed to said item;
wherein said tagging data comprises of a Unique ID (207), a Serial Number, a Reference Number and a key (206);
at least said Unique ID is encrypted into ciphertext using said key, and stored in the tagging device;
configuring a relational database table, wherein the database
contains at least said Unique ID, said Reference Number and key;
exclusive of said Serial Number of said tagging data;
assigning a token to a blockchain account of the current owner and storing the token value in a specific record of the database;
receiving ciphertext, Serial Number and Reference Number from said tagging device and generated by the current owner of the item;
wherein said tagging device Reference Number identifies the specific record in said relational database table having the same Reference Number;
confirming the authenticity of said item by matching the tagging data wherein the matching comprises of:
accessing the related relational database table specific record identified by said Reference Number;
retrieving the key from said relational database table record;
decrypting the ciphertext using said key; and
verifying data are a match when the Unique ID in said relational database table record and decrypted ciphertext are identical.

2. A computer-implemented method of authenticating the ownership of an item as claimed in claim 1 wherein said tagging device further contains a COUNT value (210) and a padding value (209) which is encrypted with the Unique ID into ciphertext using said key (206).

3. A computer-implemented method of authenticating the ownership of an item as claimed in claim 1 wherein said relational database table further contains a Customer ID value representing said current owner's information, a product ID value representing said item's information and a Token Name value representing the name that is given to said token for securing ownership data of said item.

4. A computer-implemented method of transferring ownership of an item that has been authenticated using the method as claimed in claim 1, the method of transferring comprising:
transferring said token from the current owner's blockchain account to a blockchain account of an administrator;
transferring the item to a buyer;
validating physical transfer of the item; and
transferring the token from the administrator account to a blockchain account of a buyer, wherein said token is represented by a public address.

5. A computer-implemented method of validating physical transfer of an item that has transferred as claimed in 4 and wherein said relational database table further contains a Customer ID value representing said current owner's information, a product ID value representing said item's information and a Token Name value representing the name that is given to said token for securing ownership data of said item, the method comprising:
retrieving the public address value of the token;
retrieving the Customer ID value from said relational database table;
generating an first hash value using the public address value and Customer ID as key and storing said first hash value in the relational database table;
generating a second hash value using the first hash value and Product ID as key and storing said second hash value in the relational database table; and
generating a third hash value using the second hash value and Token Name value as key and storing said third hash value in the relational database table;
generating a final hash value using the third hash value and Serial Number value as key and storing said final hash value in the blockchain as transaction message 2.

6. A computer-implemented method of validating physical transfer of an item that has transferred as claimed in 4 and wherein said relational database table further contains a Customer ID value representing said current owner's information, a product ID value representing said item's information and a Token Name value representing the name that is given to said token for securing ownership data of said item, the method comprising:
retrieving the public address value of the token;
retrieving the Customer ID value from said relational database table;
generating an first hash value using the public address value and Customer ID as key and storing said first hash value in the relational database table;
generating a second hash value using the first hash value and Product ID as key and storing said second hash value in the relational database table; and
generating a third hash value using the second hash value and Token Name value as key and storing said third hash value in the relational database table;
generating a final hash value using the third hash value and Serial Number value as key and storing said final hash value in the blockchain as a transaction message n+2;
wherein n is the number of transactions.

7. A computer-implemented method of validating physical transfer of an item that has transferred as claimed in claim 5, the method comprising:
retrieving the public address value of the token;
retrieving the Customer ID value from said relational database table;
generating an first hash value using the public address value and Customer ID as key and storing said first hash value in the relational database table;
generating a second hash value using the first hash value and Product ID as key and storing said second hash value in the relational database table; and
generating a third hash value using the second hash value and Token Name value as key and storing said third hash value in the relational database table;
generating a final hash value
wherein the final hash value is derived using the third hash value and the first Serial Number in said sequence as key and repeated using the generated hash value and the Serial Number as key until the last of the serial numbers in the sequence; and
storing said final hash value in the blockchain as transaction message 2.

8. A computer-implemented method of validating physical transfer of an item that has transferred as claimed in claim 6, the method of validating physical transfer of said item comprising:
retrieving the public address value of the token;
retrieving the Customer ID value from said relational database table;
generating an first hash value using the public address value and Customer ID as key and storing said first hash value in the relational database table;
generating a second hash value using the first hash value and Product ID as key and storing said second hash value in the relational database table; and
generating a third hash value using the second hash value and Token Name value as key and storing said third hash value in the relational database table;
generating a final hash value
wherein the final hash value is derived using the third hash value and the first Serial Number in said sequence as key and repeated using the generated hash value and the Serial Number as key until the last of the serial numbers in the sequence; and
storing said final hash value in the blockchain as transaction message n+2;
wherein n is the number of transactions.

9. A computer-implemented method of binding ownership information of a token that has been transferred as claimed in claim 7, the method comprising:
retrieving the public address value of the token and storing said value as transaction message 1;
generating a hash value using said first transaction message value and second transaction message value as key; and
storing said hash value in the blockchain as transaction message 3.

10. A computer-implemented method of binding ownership information of a token that has been transferred as claimed in claim 8, the method comprising:
generating a hash value using transaction message n+1 value and transaction message n+2 value as key; and
storing said hash value in the blockchain as transaction message n+3.
